(19) United States
(12) Patent Application Publication
(10) Pub. No.: US 2009/0019140 A1
(43) Pub. Date: Jan. 15, 2009

(54) Method for backup switching spatially separated switching systems

(76) Inventors: Norbert Lobig, Darmstadt (DE); Jurgen Tegeler, Penzberg (DE)

Correspondence Address: BELL, BOYD & LLOYD, LLP, P.O. BOX 1135, CHICAGO, IL, 60690, US

(21) Appl. No.: 10/582,590

(22) PCT Filed: Aug. 26, 2004
(86) PCT No.: PCT/EP2004/051927

§ 371 Date: Jun. 9, 2006

(30) Foreign Application Priority Data
Dec. 12, 2003 (DE) 103 58 340.8

(51) Int. Cl. G06F 15/16; G06F 15/173

(52) U.S. Cl. 709/223; 709/239

(57) ABSTRACT

A 1:1 redundancy is provided. An identical clone being assigned to each switching system that is to be protected as a redundant partner comprising identical hardware, software, and database. The transfer is done in a fast, secure, and automatic manner by a superimposed, real-time capable monitor which establishes communication to the switching systems that are arranged in pairs. The transfer to the redundant switching system is done with the aid of the network management and the central controllers of the two switching systems.

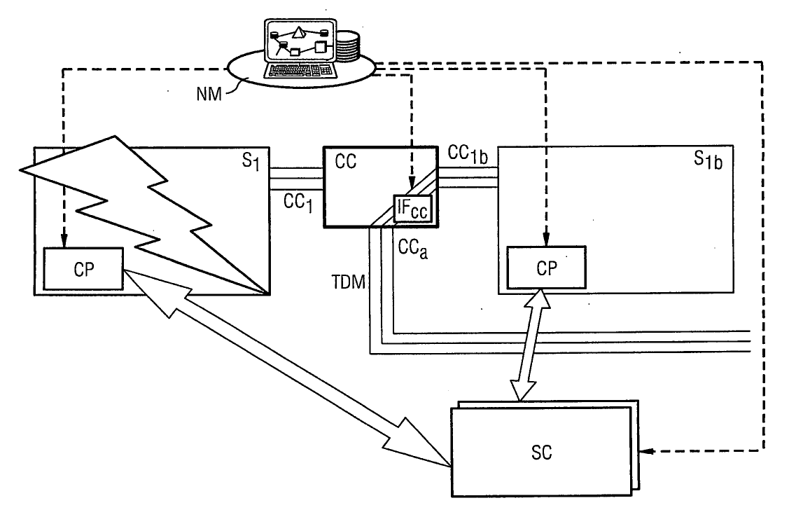

### CROSS REFERENCE TO RELATED APPLICATIONS

This application is the US National Stage of International Application No. PCT/EP2004/051927, filed Aug. 26, 2004 and claims the benefit thereof. The International Application claims the benefits of German application No. 10358340.8 DE filed Dec. 12, 2003, both of the applications are incorporated by reference herein in their entirety.

### FIELD OF INVENTION

The present invention relates to a method for backup switching spatially separated switching systems.

### BACKGROUND OF INVENTION

Modern switching systems (switch) have a high degree of internal operational reliability owing to redundant provision of important internal components. Thus in normal operation very high availability of the switching functions is achieved. However, if massive external effects (for example fire, natural disasters, terrorist attacks, the effects of war, etc.) occur, the affected provisions for increasing the operational reliability are usually of little use as original and backup components of the switching system are located in the same place and thus in the event of such a catastrophe it is highly probable that both components will have been destroyed or rendered inoperable.

### SUMMARY OF INVENTION

A geographically separate 1:1 redundancy has been proposed as a solution. Accordingly it is provided that each switching system to be protected is associated with an identical clone as a redundancy partner with identical hardware, software and database. The clone is in the booted-up state but is nevertheless inactive in switching terms. Both switching systems are controlled by a higher-order real-time capable monitor in the network which controls the changeover processes.

An object of the invention is to disclose a method for backup switching switching systems which ensures efficient changeover of a failed switching system to a redundancy partner in the event of a fault.

According to the invention communication is established to the switching systems arranged in pairs (1:1 redundancy) in the course of a 1:1 redundancy by a higher-order monitor—which can be produced in hardware and/or software. In the case of loss of communication to the active switching system, the monitor changes over to the redundant switching system with the aid of the network management and the central controllers of the two redundant switching systems.

A fundamental advantage of the invention can be seen in that the changeover operation from the active switching system to the hot standby switching system is aided by the network management and the central control units of the switching systems involved. Thus the invention can be used in particular for conventional switching systems which through-switch TDM information. Conventional switching systems usually comprise central control units of this type anyway, so additional expenditure is not required here. This solution is thus globally applicable and economical as there is substantially only the expenditure for the monitor. It is also extremely robust; dual failure of the monitor is not a problem.

Advantageous developments of the invention are recited in the dependent claims.

### BRIEF DESCRIPTION OF THE DRAWING

The invention will be described in more detail hereinafter with reference to an embodiment illustrated in the FIGURE. The FIGURE shows the network configuration on which the method according to the invention proceeds. Accordingly it is provided that an identical clone is associated with each switching system to be protected (for example S₁) as a redundancy partner (for example S_{1b}) with identical hardware, software and database. The clone is in the booted-up state but is nevertheless switching-inactive (operating state “hot standby”). Thus a highly available 1:1 redundancy, distributed over a plurality of locations, of switching systems is defined.

### DETAILED DESCRIPTION OF INVENTION

As the switching systems S₁, S_{1b} through-switch TDM information at least one cross connect device CC is additionally required which can changeover all of the TDM traffic between switching system S₁ and the redundant switching system S_{1b}. In normal operation the TDM sections of the switching system S₁ enter or exit at point CC₁ of the crossconnect device CC and exit or enter again at point CCₐ. The TDM sections of the switching system S_{1b} enter the crossconnect device CC at point CC_{1b} or have their origin there in the counter direction. Through-switching does not take place in the crossconnect device CC, however.

The two switching systems (switching system S₁ and the clone or redundancy partner S_{1b}) are controlled by the same network management system NM. They are controlled in such a way that the current version of the database and software of the two switching systems S₁, S_{1b} is kept identical. This is achieved in that each operational command, each configuration command and each software update, including patches, is identically deployed in both partners. Thus with respect to the switch in operation, the spatially displaced identical clone is defined with an identical database and identical software version.

The database basically contains all semi-permanent and permanent data. In this case permanent data is taken to mean data which is stored as code in tables and which may only be changed via a patch or software update. Semi-permanent data is taken to mean data which, for example, passes into the system via the user interface and which is stored there for a relatively long time in the form of the input. With the exception of the configuration states of the system this data is not itself changed inter alia by the system. The database does not contain transient data which accompanies a call and which the switching system stores only briefly and which does not have any significance beyond the duration of a call inter alia, or additional information which constitutes transient overlays/additions to configuratively predetermined basic states (thus a port could be active in the basic state but be instantaneously inaccessible owing to transient (temporary) disruption.

The switching systems S₁, S_{1b} are activated from outside, i.e. by a higher-order real-time capable monitor located outside of switching system S₁ and switching system S_{1b}. The monitor can be produced in hardware and/or software and changes over to the clone in the event of a fault. This case is to be provided in particular if there is no direct connection between monitor and network management. According to the present embodiment the monitor is constructed as a control device SC and doubled for security reasons (local redundancy).

This configuration with switching-active switching system S₁ should be the default configuration. This means that switching system S₁ is switching-active while the switching system S_{1b} is in a “hot standby” operating state. This state is marked by a current database and full activity of all components, wherein, in the normal state, the crossconnect device protects the redundant switching system S_{1b} from access to or transportation of payload and signaling.

As TDM information flows are sent/received by the switching system S₁, a crossconnect device CC is necessary. This has (at least) one packet-based interface IF_{cc} (active all the time) and is connected to the network management NM. A connection to the control device SC is not necessarily provided here. At any time the network management has the possibility of changing over the crossconnect device CC such that the peripheral equipment of the switching system S₁ can be switched to the switching system S_{1b}. That the two geographically redundant switching systems S₁, S_{1b} and the network management NM and the locally doubled control device SC should each be clearly spatially separate is to be regarded as a fundamental aspect.

The control device SC regularly, or as required, transmits the current operating state of the switching systems S₁ and S_{1b} (act/standby state of the interfaces) and its own operating state to the network management NM. The functions of the control device SC can optionally be partially or completely carried out by the network management NM. For security reasons the network management NM should have the function of being able to also bring about the above-described changeovers manually at any time. The automatic changeover can optionally be blocked, so the changeover can only be carried out manually.

In one configuration of the invention the host computer of a further switching system is used as the control device SC. There is thus a control device with maximum availability. The functionality of the control device SC can also be reduced to pure recognition of the need for the backup case. Thus the decision to changeover is shifted via the network management to the user. The multiplexer and crossconnect device connected upstream are no longer directly controlled by the control device SC with respect to the backup switching operation, but indirectly via the network management system.

Establishment of a direct communications interface between switching system S₁ and switching system S_{1b} is also considered. This can be used to update the database, for example with respect to SCI (Subscriber Controlled Input) and fee data as well as for exchanging transient data of individual connections or essential additional transient data (for example H.248 association handle). Disruption to operation can thus be minimized from subscriber and user perspectives.

The semi-permanent and transient data can subsequently be transmitted from the respectively active switching system into the redundant standby switching system in a cyclical time pattern (update). The update of the SCI data has the advantage that the cyclical restore to the standby system is avoided and up-to-dateness with respect to SCI data prevails in the standby system at any time. The takeover of the peripheral equipment by a backup system can be concealed by the update of stack-relevant data, such as the H.248 association handle, and the downtimes can be reduced even more.

A fault scenario of the configuration according to the FIGURE is described hereinafter:

In the course of booting up both switching systems attempt to reach the control device SC. This is possible as the control device SC is known to the respective central controllers CP of the switching systems S₁ and S_{1b}. At the same time the control device SC also attempts to address the two switching systems S₁ and S_{1b}. Communication takes place via a control interface. This can be configured so as to be IP-based, TDM-based, ADM-based, etc. The control device SC defines which of the two switching systems S₁ and S_{1b} should assume the “act” and “standby” operating states. According to the present embodiment, this should be the switching system S₁. Communication between switching system S_{1b} and the controller either does not get underway as a result of this establishment, or the control device SC explicitly communicates to the switching system S_{1b} that it is to assume the “standby” operating state.

Owing to the above-described network structure both switching systems S₁ and S_{1b} maintain the same permanent and semi-permanent data in the database and both are switched on and booted up. The crossconnect device CC connected upstream connects the peripheral equipment to switching system S₁. The sections between the crossconnect device CC and the switching system S_{1b} are switched on and faultless but do not carry any signaling nor conduct any traffic. Switching system S₁ is switching-active. Switching system S₁ is also booted up and has undisrupted TDM sections in the direction of AN, DLU and trunks of remote public and private switching centers. Owing to the crossconnect device CC that is connected upstream, signaling to AN, DLU, trunks of remote public and private switching centers and PRI is disrupted in each case, however. As a result switching system S_{1b} cannot accept any switching traffic.

From the perspective of the network management NM the two switching systems are available and are updated in the same manner thereby during operation. Alarms, which lead to maintenance measures, are also handled for both switching systems via the network management NM. However, complete failure of the signaling in the switching system S_{1b} is operating state-specific and does not lead to maintenance measures (IDLE operating state). If makes sense for switching system S_{1b} not to generate these alarms at all if it receives explicit communication from the control device SC that it has the standby function.

The network management NM controls the crossconnect device CC on its own. The device is constructed in double format and substantially represents the required double portion of the relevant transmission network. The control device SC and the central controllers CP of the two switching systems S₁ and S_{1b} together verify the configuration by exchanging test messages at an interval of a few seconds. This can for example take place in that, with the aid of the central controller CP, the active switching system S₁ cyclically reports to the control device SC and receives a positive acknowledgement (for example every 10 s), whereas the cyclical reporting of switching system S_{1b} to the control device SC is not acknowledged or is responded to with a negative acknowledgement.

It will be assumed hereinafter that communication between switching system S₁ and control device SC is disrupted. This can mean that switching system S₁ has failed, a network problem has occurred or the control device SC has failed. Only the first case (switching system S₁ has failed) will be looked at as an embodiment.

Cyclical test messages are exchanged between the control device SC (if intact) and the central controllers CP of the two switching systems S₁ and S_{1b}. The cyclical test messages are exchanged between the control device SC and the central controller CP of the active switching system S₁ in that, with the aid of its central controller CP, the active switching system S₁ cyclically reports to the control device SC and thereupon receives a positive acknowledgement (for example every 10 seconds). The cyclical test messages are exchanged between the control device SC and the central controller CP of the hot standby switching system S_{1b} in that, with the aid of its central controller CP, the hot standby switching system S_{1b} reports to the control device SC and thereupon does not receive an acknowledgement or receives a negative acknowledgement (for example every 10 s).

The control device SC (if intact) accordingly (failure) reports a verified, inadmissibly long-lasting loss of communication to the network management NM with the desire for backup switching to switching system S_{1b}. As the control device SC has monitored the availability of switching system S_{1b} in the past, and the latter does not appear to be disrupted, this desire is justified by the expectation of being able to changeover to an available switching system S_{1b}. The network management NM acknowledges the changeover request to the control device SC and issues appropriate switching commands to the crossconnect device CC or the transportation level. This can take place automatically or with user intervention. With positive acknowledgement of the network management system NM, the control device SC acknowledges the cyclical requests from switching system S_{1b} positively and thus, with the aid of the central controller CP, switches the switching system S_{1b} explicitly into the switching-active state. The control device SC also acknowledges the cyclical requests from switching system S₁ negatively on receipt in future and thus, with the aid of the central controller CP, switches the switching system S₁ explicitly into the switching-inactive state.

Signaling failures are successively eliminated by the changing over of the crossconnect device CC. By establishing communication to the control device SC or as result of the positive acknowledgement from the control device SC, signaling failures in the switching system S_{1b} can henceforth be expediently indicated to the network management NM by way of an alarm. Switching system S_{1b} goes into operation and switching system S₁ is separated from the peripheral equipment and the remote level.

After repairing the switching system S₁ that has failed (or following the end of communication between the control device SC and the switching system S₁), the control device SC recognizes the re-availability of the system and monitors it for subsequent failure scenarios. Automatic switching back to switching system S₁ does not necessarily occur as this is disadvantageous with regard to the possible loss of connections and does not bring about any other advantages either.

Before the disruption in communication with control device SC or before its failure, switching system S₁ had faultless operation and contact with the control device SC. After error recovery following repair or following the end of the disruption to communication, the switching system S₁ implicitly or explicitly experiences its “standby” operating state via the control device SC. In other words, if switching system S₁ had failed, following repair it assumes an operating state (“standby”) which is characterized in that it cannot establish any contact with the control device SC (implicit). The “standby” operating state is optionally communicated to the switching system S₁ by the control device SC (explicit). The switching system S₁ is separated from its partners in the network and cannot establish any signaling connections as a result of the setting of the transmission network that is connected upstream. In the first case the switching system S₁ indicates the protocol failures by way of an alarm. In the second case it may suppress or cancel these alarms as they are clear consequences of the configuration and are not faults.

If the changeover could be attributed merely to a temporary disruption in the communication between control device SC and switching system S₁, the switching system S₁ must indicate by way of alarms the signal failures associated with clearing of the TDM sections on switching system S_{1b}. When communication between control device SC and switching system S₁ is available again, in the case of an explicit standby configuration, the alarms can be cancelled again by the control device SC.

If switching system S₁/S_{1b} is a local switching center with subscribers, the subscriber controlled inputs (SCI) that have passed into the respectively active switching system S₁/S_{1b} are merged from the weekly backup operation of the active switching system S₁ into the database of the standby system. Thus SCI data is available with an acceptable level of expenditure and yet so as to be virtually current in the standby switching system. In the case of a pure trunk switch the backup for subscriber data from the active switch and restore into the standby switch is not necessary.

As already addressed, the solution according to the invention can also be applied to disrupted communication between switching system S₁ and control device SC as long as the switching system S₁ is still capable of functioning as a platform. In this case the control device SC has no contact with the switching system S₁ but does have contact with the switching system S_{1b}. However, the switching system S₁ is still switching-active and has contact with its switching network partners. The control device SC accordingly activates the redundant switching system S_{1b} after noticing a (assumed) failure of switching system S₁ but cannot deactivate switching system S₁. This occurs de facto however as a result of the changeover of the transmission network connected upstream.

1-10. (canceled)

11. A method for backup switching spatially separated switching systems, comprising:
providing a pair of switching system arranged in a one-to-one redundancy, the pair comprising:
a first switching system in an active operating state, and
a redundant switching system in a hot standby operating state;
establishing a first communication between a real-time monitor and the first switching system; and
changing over to the redundant switching system after a loss of the communication between the monitor and the first switching system.

12. The method according to claim 11, further comprising exchanging cyclical test messages between the monitor and a first central controller in the first switching system and a second central controller in the redundant switching systems.

13. The method according to claim 12, further comprising receiving by the monitor, a positive acknowledgment in response to the test message from the active switching system.

14. The method according to claim 13, further comprising receiving by the monitor, a negative acknowledgment or no acknowledgement in response to the test message from the hot-standby switching system.

15. The method according to claim 14, further comprising
establishing a second communication between the monitor and a network management;
reporting the loss of communication to the active switching system from the monitor to the network management; and
sending a changeover from the network management command to the monitor and a crossconnect device.

16. The method according to claim 13,
wherein the change over to the redundant switching system is controlled via the monitor by acknowledging cyclical requests by the hot standby switching system with a positive acknowledgement, and
wherein central controller of the hot-standby switching system changes over to the active operating state.

17. The method according to claim 16, wherein automatic switching back to the configuration existing before the loss of communication does not occur after an end of the loss of communication.

18. The method according to claim 17, wherein the end of the loss of communication is reported to the network management.

19. The method according to claim 11, wherein automatic switching back to the configuration existing before the loss of communication does not occur after and end of the loss of communication.

20. The method according to claim 19, wherein the end of the loss of communication is reported to the network management.

21. The method according to claim 11, wherein a network management system initiates the changeover via the monitor.

22. The method according to claim 21, wherein the network management evaluates a backup switching requirement of a plurality of monitors and the change over is made only if any of the monitors that can access the network management makes the demand.
